(19) United States
(12) Patent Application Publication
(10) Pub. No.: US 2011/0058651 A1
(43) Pub. Date: Mar. 10, 2011

(54) DEVICE AND METHOD FOR X-RAY EXAMINATION OF AN OBJECT FOR MATERIAL DEFECTS BY MEANS OF X-RAYS

(76) Inventors: JENS FUERST, Herzogenaurach (DE); MATTHIAS GOLDAMMER, Muenchen (DE); MARKUS KOWARSCHIK, Langenzenn (DE); JUERGEN STEPHAN, Puchheim (DE)

(21) Appl. No.: 12/878,106

(22) Filed: Sep. 9, 2010

(30) Foreign Application Priority Data
Sep. 9, 2009 (DE) 10 2009 040 769.3

(51) Int. Cl. G01B 15/06

(52) U.S. Cl. 378/58

(57) ABSTRACT

In a device and a method for testing an object for material defects, a multi-emitter x-ray source, at least one x-ray detector and a control system to activate emitters of the multi-emitter x-ray source are thereby used. A selective activation of individual emitters or of a portion of the emitters is conducted according to the requirements of at least one item of information related to the tested object. The Flexible and low-cost materials testing is achieved.

### BACKGROUND OF THE INVENTION

1. Field of the Invention

The present invention concerns a device and a method to examine an object for material defects by means of x-rays.

2. Description of the Prior Art

X-ray testing methods are used in non-destructive substance and material testing in industrial manufacturing. A variety of components (that includes motors, robot components, vehicle parts and many others) can be tested. In non-destructive x-ray examination, the sample pieces or test subjects are typically introduced into a housing that is externally shielded from x-ray radiation and there are exposed with x-rays inside the housing. Inclusions or cavities, material defects, internal fractures and tears that are not visible from the outside can then be analyzed by means of x-rays.

Conventional x-ray exposures of objects provide a two-dimensional projection of the objects, which allows a determination of the attenuation or absorption of the x-ray radiation upon penetration of the object. Irregularities or fluctuations that are identified in the two-dimensional projection image provide information about the composition of the object, and therefore also about material defects.

Individual two-dimensional projections have the disadvantage that no information about the object is obtained with regard to the direction of the x-ray radiation because the variable measured by the projection represents a variable integral to the path through the object. Tomographic methods that also allow a certain resolution in the third dimension are therefore also used for materials testing. For example, in DE 19 955 937 A1 a method for materials testing is described that is based on computed tomography. In conventional computed tomography, an x-ray source is driven around the object to be examined along what is known as a trajectory, wherein x-ray exposures are taken at regular intervals. A number of projections from different directions is thus obtained, from which a three-dimensional image of the object can be reconstructed with mathematical methods.

However, computed tomography (CT) for material testing entails certain disadvantages. One of these disadvantages is that conventional CT systems are limited in size. In addition, in a specific class of tests the object is tested under defined physical conditions, for example under the effects of pressure or stress loading. With regard to these tests, DE 10 2007 001 928 A1 proposes to form an integrated system that is composed of a CT system that has a device to cause load states of examined objects. The already high costs of computed tomography systems increase further if special productions are provided for specific materials testing types.

Therefore there is a need for x-ray testing methods for materials that are flexible and allow a three-dimensional reconstruction of regions of the object, as necessary. The corresponding applications should be low-cost, primarily in view of the high costs of conventional CT apparatuses, and should not entail any greater limitations with regard to the size of the examined object.

U.S. Pat. No. 6,341,153 takes one step in this direction. This device described therein makes use of the fact that an acquisition of a very limited number of x-ray projections (namely 3) already allows a reconstruction that enables conclusions about the composition of the object with regard to all three dimensions. It is also unnecessary to completely orbit the tested object as in conventional CT technology. Instead, the projections are acquired only in a limited angle range. This achieves a usable x-ray analysis apparatus, but it is desirable to design x-ray systems for material analysis to be even more efficient and low-cost.

### SUMMARY OF THE INVENTION

An object of the present invention is to improve material testing with x-rays.

The term “material defect” as used herein encompasses all irregularities of an object with regard to shape and composition, in particular cavities, contractions, tears and others as well.

A basis of the invention is to use a multi-emitter x-ray tube or x-ray source for the material testing. Such x-ray tubes have a number of emitters (for example on the order of 100 emitters, wherein significantly more—for example over 1000 emitters—can also be provided as needed) that are typically formed by nanotubes. The invention is also based on the consideration that multi-emitter x-ray tubes are very flexible given use in materials testing.

According to the invention, a functional superiority relative to systems with conventional x-ray tubes is achieved via a targeted activation of emitters of the x-ray tube. Design properties of the system according to the invention can thereby be adapted with regard to the functional use capabilities resulting due to the use of a multi-emitter x-ray tube.

In particular, in this way a system for materials testing can be provided which operates with a purely stationary x-ray source without therefore being tied to the qualitative limitations of a conventional, stationary x-ray system.

The device according to the invention for the testing of an object for material defects has a multi-emitter x-ray source or x-ray tube; at least one detector; and a control system to activate emitters of the multi-emitter x-ray source. The device is designed for a selective activation or control of individual emitters or of a portion of the emitters according to the requirements of at least one item of information related to the tested object.

Multi-emitter x-ray sources have the advantage that there are barely any limitations with regard to shape and size. In particular, the region in which the emitters are arranged can be established corresponding to the sought applications. For materials testing it is reasonable to select the dimensions of the x-ray tube for an optimally good utilization of the measurement area of the detector. For example, if the detector is a line detector, in the x-ray tube emitters can be arranged along a length that essentially corresponds to the line length of the detector.

For a high flexibility with regard to conducted materials tests it is advantageous if different exposure directions can be provided. This function can be realized via collimators that are provided for the adjustment of different exposure directions. An alternative realization exists in the arrangement of the emitters for different exposure directions. Measures based on collimation and emitter arrangements selected with regard to exposure directions can thereby be combined for optimally high flexibility in the establishment of exposure directions.

In an embodiment of the arrangement according to the invention, a number of detectors (for example line detectors) that can be exposed by the x-ray tube without changing the position of the x-ray tube, for example by activating different emitters and/or establishing different exposure directions. Instead of multiple detectors, a flat panel detector can be used that, by the dimensioning of the detector surface, offers variation possibilities with regard to the position of the examined object and with regard to the exposure direction.

The invention also encompasses a method to test an object for material defects by means of x-rays.

According to this method, at least one item of information related to the object is provided for a control system and the control system activates at least one emitter of a multi-emitter x-ray source according to the requirements of the at least one item of information. An x-ray acquisition of the object that serves to identify material defects is implemented by means of the at least one emitter of the multi-emitter x-ray source and by means of a detector.

The at least one item of information can be information with regard to diameter, shape, material or position of the object. A number of these items of information can also be used for the control of the multi-emitter x-ray source. According to embodiments of the subject matter of the invention, according to the requirements of the at least one item of information the position of the at least one activated emitter is determined within the x-ray tube or the number of the activated emitters is established. Parameters such as position of the focus or foci, diameters of the beam and radiation intensity can be regulated in this way according to the stipulations of the testing requirements. It is also useful to establish the radiation direction of the at least one activated emitter according to the at least one item of information. If the shape of the object is present as information (for example as CAD data), the exposure direction can be selected so that the volume to be exposed remains as small as possible in order to be able to detect an optimally high transmitted radiation dose via the detector.

According to one embodiment of the subject matter of the invention, at least one item of control information for the testing of an object during the examination is altered or, respectively, adapted according to the requirements of testing information. For example, during the materials test information about the shape or composition of the object can be obtained and used for the optimization of the exposure parameters (for example exposure direction or, respectively, exposure angle). In one embodiment the method can have a control unit with learning capability for properties of the tested object during the test that implements a corresponding adaptation of the control of the test.

The use of a multi-emitter opens up the possibility of obtaining a number of exposures for a region of the object from different directions by means of the x-ray tube given a stationary source (i.e. without the radiator traversing a trajectory), in that different emitters and/or a different beam collimation are/is set for the exposures. As in a tomosynthesis, a three-dimensional representation of the object region can be generated from the plurality of exposures.

A number of exposures can be obtained simultaneously (for the same object or different objects) by the simultaneous activation of different emitters of the x-ray tube, such that the material test can be implemented more efficiently.

### BRIEF DESCRIPTION OF THE DRAWINGS

FIG. 1 schematically illustrates a conventional materials test with x-rays.

FIG. 2 shows a multi-emitter x-ray tube.

FIG. 3 schematically illustrates a materials test by means of a multi-emitter x-ray tube in accordance with the invention.

FIG. 4 is a side view of the system of FIG. 3.

FIG. 5 shows a collimator arrangement for different exposure directions of a multi-emitter x-ray tube.

FIG. 6 shows a collimator and emitter arrangement for a multi-emitter x-ray tube to generate beams in different directions.

### DESCRIPTION OF THE PREFERRED EMBODIMENTS

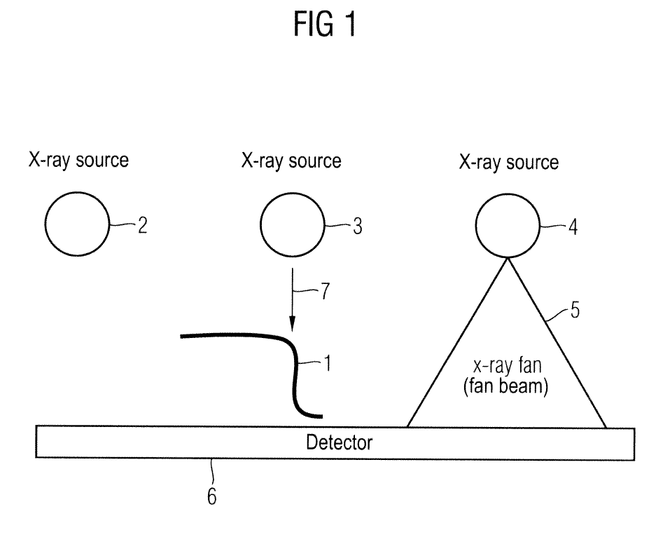

A segment of an object 1 that is to be tested is shown in FIG. 1. It is thereby a metal component, for example, that should be used in a vehicle. This is moved in the z-direction, i.e. into the plane of the drawing (by means of a conveyor belt that is not drawn, for example) and thereby exposed with test radiation. In the conventional system shown in FIG. 1, three conventional x-ray sources 2 through 4 are used for the testing of objects. These x-ray sources 2 through 4 generate an x-ray beam 5 which is, for example, a fan beam. In x-ray acquisitions, x-ray radiation transmitted through the object 1 to be tested is received by a detector 6. In this manner, projections are thus obtained that allow conclusions about the material properties of the object 1.

Conventional x-ray tubes as used in FIG. 1 essentially include a vacuum chamber with housing in which a cathode and an anode are enclosed. The cathode thereby acts as a negative led that emits electrons to the positive anode. The electrons are attracted by the anode and are strongly accelerated by an electrical field between the anode and cathode. The anode typically is composed of a metal, for example tungsten, molybdenum or palladium. When the electrons bombard the anode the majority of their energy is converted into heat. Only a fraction of the kinetic energy can be converted into x-ray photons, which are emitted from the anode in the form of an x-ray beam. The x-ray beam generated in this manner exits the vacuum chamber via a radiation-permeable window made of a material with low atomic number.

Conventional 2D x-ray control systems with classical rotating or stationary anode concepts typically have one or only a small number (normally <5) of such x-ray tubes. Due to these limitations, the system shown in FIG. 1 has problems finding all material defects. Under the circumstances a material defect (for example a tear or an inclusion) in the indicated direction 7 cannot be detected because the x-ray radiation does not penetrate this material thickness and a total absorption ensues in the scanning plane that is relevant to the test.

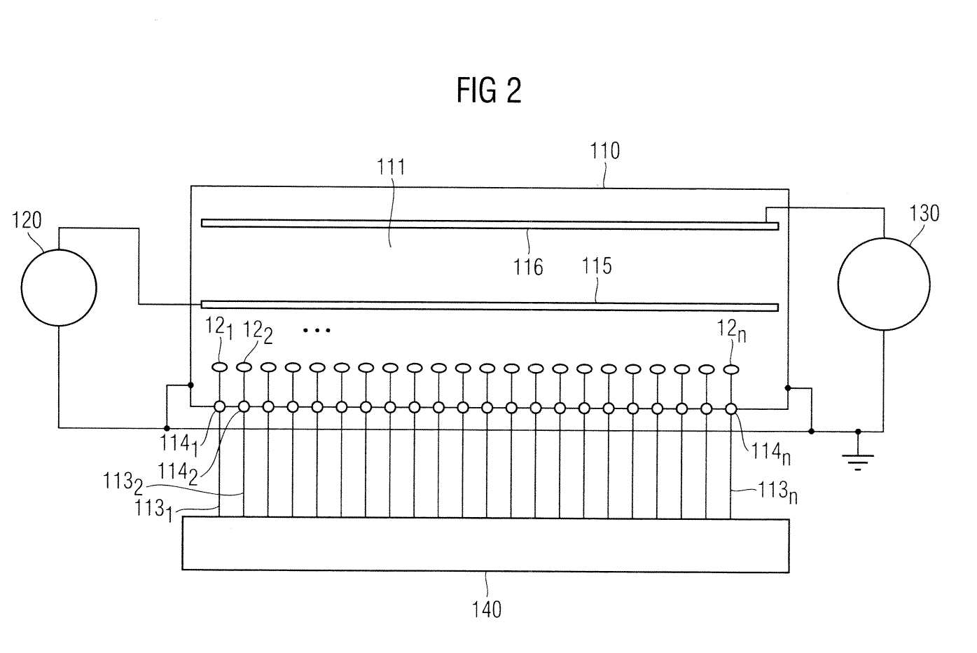

The basis of the present invention is that multi-emitter x-ray tubes are used in x-ray testing methods. Such x-ray tubes are normally formed by electron emitters made of carbon nanotubes (CNT). For example, such x-ray tubes are described in the article “Stationary Scanning X-ray Source Based on Carbon Nano Tube Field Emitters”, appearing in 2005 in Applied Physics Letters 86, 184104, and in the Patent Application WO 2004/110111 A2. Such a CNT x-ray tube is also shown in FIG. 2.

A multi-emitter x-ray tube 110 with n of CNT cathodes 12₁ . . . 12ₙ for the emission of electrons in an evacuated region 111 is schematically shown in FIG. 2. Each of the CNT cathodes 12₁ . . . 12ₙ is fed via a separate cathode line 113₁ . . . 113ₙ which is directed through a respective vacuum bushing 114₁ . . . 114ₙ into the evacuated region 111. The individual emitters can be selectively activated or, respectively, switched on and off by means of the cathode line 113₁ . . . 113ₙ. A grid 115 and an anode 116 are also arranged in the evacuated region 111. Located outside of the evacuated region 111 are additional components of the system 100 in which the x-ray tube 110 is embedded: a grid power supply 120 electrically connected with the grid 115; an anode power supply 130 electrically connected with the anode 116; and a controller 140. Typical grid voltages are 5 kV; typical anode voltages are between 20 kV and 180 kV. The individual CNT cathodes can be associated with associated emitters for the multi-emitter x-ray tube shown in FIG. 2. However, within the scope of this invention the term “emitter” is to be understood more broadly, namely as a separate controllable electrical or x-ray emission function. The realization of this function does not necessarily have to occur by means of a dedicated device element. For example, it is possible for a device element of complex shape to provide emission functions.

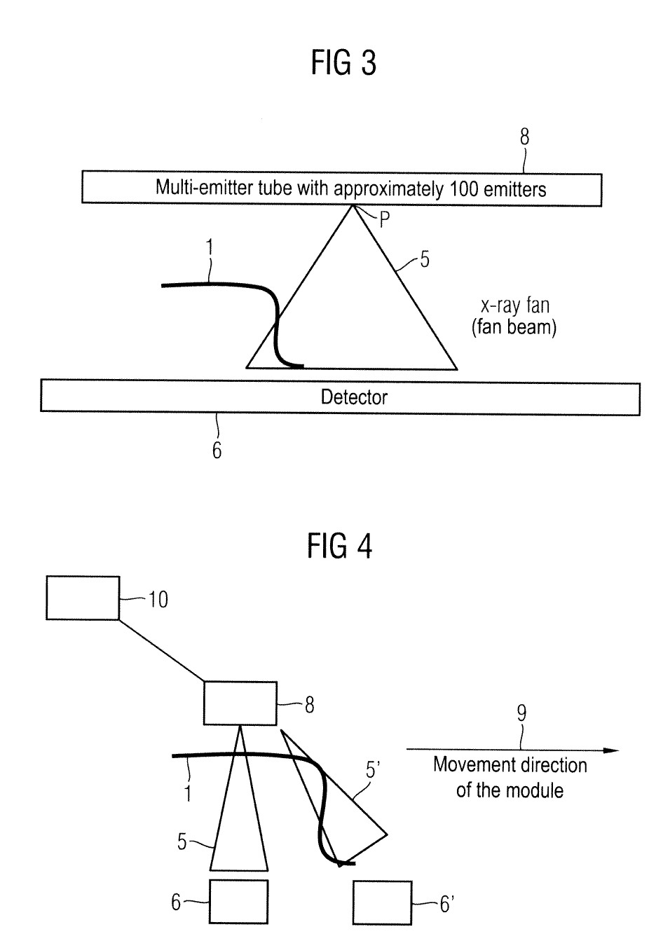

In FIG. 3 a multi-emitter tube 8 (for example with approximately 100 emitters) is used for the materials testing. As in FIG. 1, the movement direction of an examined object is thereby into the plane of the drawing. Such tubes can in principle be produced as needed, meaning that the dimensions can be established according to the requirements provided by the test stand. In the present case, tube 8 and detector 6 are matched to one another in terms of size so that the tube 8 can expose the entire test stand or, respectively, detector 6. A flat beam 5 generated by the tube at point P is shown. With the use of a controller, the position of the focus on the tube 8 can be varied depending on the test via activation of correspondingly positioned emitters. A significant improvement relative to the conventional test according to FIG. 1 that multiple x-ray sources are no longer required, and a significantly greater flexibility is achieved with regard to the specification of the location of the focus.

The selection of the parameters—in particular the activated emitters or, respectively, the settings of the multi-emitter tube 8—is advantageously made according to object properties of the tested object 1. These object properties are initially the position of the object that so that a region to be tested can be detected as well as possible. Given a known shape of the object, other criteria can additionally play a role, for example the thickness of the material to be penetrated in a projection. Specifically with voluminous objects it is reasonable to establish projection angles in which the thickness of the volume to be penetrated is optimally reduced in order to ensure that sufficient x-ray radiation is transmitted for a qualitatively high-grade projection. For this purpose it is desirable to also vary the direction of the x-ray beam as a parameter. An additional reason for variations of the direction of the x-ray radiation is an acquisition of multiple (three or more) projections for an object region from which a three-dimensional reconstruction can be composed in the course of a type of tomosynthesis. This is indicated in FIG. 4, which reproduces a lateral depiction of the test scenario from FIG. 3.

The object 1 shown in figures should be an object that is symmetrical with regard to a rotation of 45° so that the object has the shame shape in the presentation perspective of FIG. 4 as in FIG. 3. Here it is provided that the object 1 is conveyed on a conveyor belt (not shown) carrying components in the movement direction indicated by arrow 9. The multi-emitter x-ray tube 8 is controlled or, respectively, set by means of a control device 10 (for example PC, computer console, etc).

An additional beam 5′ and an additional detector 6′ that illustrate the acquisition of an additional projection are respectively shown in FIG. 4. These projections can be produced simultaneously in a multi-emitter tube by means of activation of different emitters, meaning that the object 1 is always scanned at two points in the present case. Given a corresponding setting of transport speed and acquisition order, it can be ensured that two projections are present for a tested region of the object 1. This procedure can be expanded to more than two projections (for example three if an additional detector is provided on the left side of the detector 6). A sufficient number of projections is therefore obtained for the three-dimensional image composition.

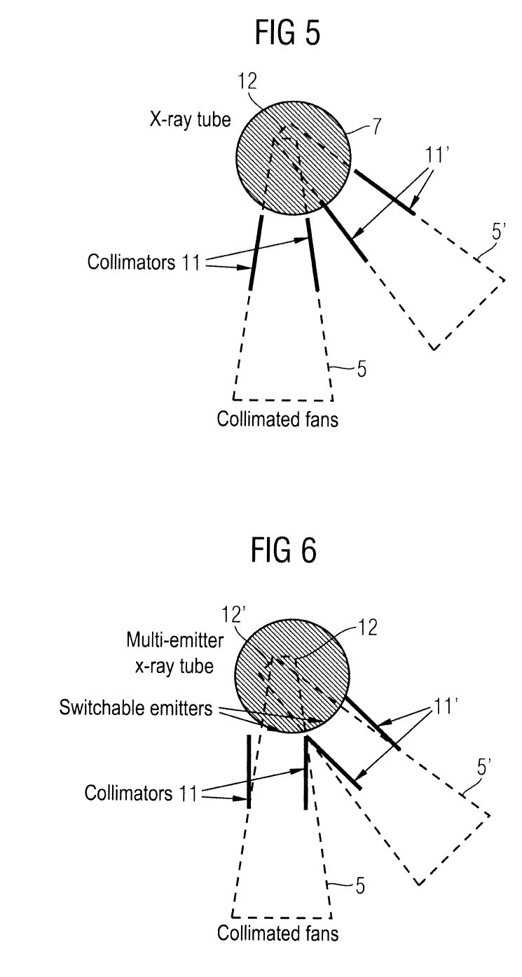

A cross section of the x-ray tube 7 is shown in FIG. 5 which is depicted as round for a better presentation of the principle in contrast to FIG. 4. In this x-ray tube 7 the position 12 of the anode is shown schematically. It is to be imagined that a plurality of parallel emitters with corresponding anodes extends into the plane of the drawing or out of the plane of the drawing along the oblong tube. Furthermore, two x-ray beams 5 and 5′ are shown extending in different directions. These are generated in suitable shapes by means of wedge-shaped, arranged collimators 11 and 11′. Utilization of multiple flat beams is also simultaneously possible due to the wedge-shaped arrangement of the collimators 11 and 11′ or, respectively, via slotted collimators. In FIG. 6 an embodiment is schematically shown wherein anodes or emitters 12 and 12′ with differing alignment are provided. The alignment of the anodes or emitters 12 and 12′ conforms to the flat beams 5 and 5′ that are to be generated. Suitable collimators 5 and 5′ are associated. Through the multi-emitter technique it is possible to rapidly switch between emitters that are equipped with collimators of different alignment. A changing of the beam direction and beam collimation is thereby possible with high switching frequency without moving parts.

Although modifications and changes may be suggested by those skilled in the art, it is the intention of the inventors to embody within the patent warranted hereon all changes and modifications as reasonably and properly come within the scope of their contribution to the art.

We claim as our invention:

1. A device for testing an object for material defects, comprising:
a multi-emitter x-ray source comprising a plurality of emitters that each individually emit x-rays;
at least one x-ray detector, said x-ray source and said at least one x-ray detector being configured to irradiate, with x-rays from said x-ray source, an object to be tested for material defects, and to detect x-rays, at said at least one x-ray detector, attenuated by said object; and
a control system connected to said x-ray source to individually activate said emitters, said control system being supplied with at least one item of information that describes an attribute of said object that is relevant for testing said object, and said control system being configured to activate a subset of said emitters, said subset comprising at least one but not all of said emitters, dependent on said at least one item of information.

2. A device as claimed in claim 1 wherein said at least one detector comprises a measurement area, and wherein said x-ray source comprises dimensions for optimum utilization of said measurement area.

3. A device as claimed in claim 1 wherein said at least one detector is a line detector, and wherein said emitters of said x-ray source are arranged along a length substantially corresponding to a line length of said line detector.

4. A device as claimed in claim 1 comprising collimators that interact with said x-rays emitted by said x-ray source to selectively expose said object to said x-rays from different exposure directions.

5. A device as claimed in claim 4 wherein said x-ray source comprises different emitters respectively for radiating said object from said different exposure directions.

6. A device as claimed in claim 1 comprising a plurality of x-ray detectors that detect x-rays emitted by said x-ray source.

7. A method for testing an object for material defects by x-ray examination of the object, comprising the steps of:
providing a computerized control system with at least one item of information representing an attribute of an object to be tested for material defects, said attribute being relevant to testing of said object;
from said control system, activating a subset of emitters of a multi-emitter x-ray source dependent on said at least one item of information, said subset comprising at least one but not all of said emitters of said multi-emitter x-ray source; and
irradiating said object with said subset of said emitters of said multi-emitter x-ray source and detecting x-rays emitted by said subset of emitters, and attenuated by said object, with an x-ray detector.

8. A method as claimed in claim 7 comprising forming said multi-emitter x-ray source with nanotube cathodes.

9. A method as claimed in claim 7 comprising providing said computerized control system with at least one item of information selected from the group consisting of diameter, shape, material and spatial position of said object.

10. A method as claimed in claim 7 comprising, from said at least one item of information, determining a spatial position of said subset of emitters within said x-ray source for irradiating the object.

11. A method as claimed in claim 7 comprising determining, from said at least one item of information, a number of said emitters in said subset.

12. A method as claimed in claim 7 comprising determining, from said at least one item of information, a radiation direction for irradiating said object.

13. A method as claimed in claim 7 comprising selecting, dependent on said at least one item of information, a radiation direction of said subset of emitters.

14. A method as claimed in claim 7 comprising obtaining a plurality of respective exposures from different directions with said multi-emitter x-ray source for a region of the object with different subsets of said emitters or different collimation of x-rays in the respective exposures.

15. A method as claimed in claim 14 comprising reconstructing a three-dimensional representation of said object from said plurality of exposures.

16. A method as claimed in claim 14 comprising obtaining said plurality of exposures simultaneously.

17. A method as claimed in claim 7 comprising, in a processor, evaluating at least one exposure of said object, and adapting said at least one item of information provided to said control system dependent on a result of said evaluation.
